(19) United States
(12) Patent Application Publication
(10) Pub. No.: US 2014/0009421 A1
(43) Pub. Date: Jan. 9, 2014

(54) METHOD FOR CONTROLLING LOCK FUNCTION AND ELECTRONIC DEVICE THEREOF

(71) Applicant: Samsung Electronics Co., Ltd., Gyeonggi-do (KR)

(72) Inventors: Myung-Hwan LEE, Seoul (KR); Sun-Young MIM, Seoul (KR); Jin PARK, Gyeonggi-do (KR); Hong-Joon PARK, Seoul (KR)

(21) Appl. No.: 13/936,442

(22) Filed: Jul. 8, 2013

(30) Foreign Application Priority Data
Jul. 6, 2012 (KR) 10-2012-0073912

(51) Int. Cl. G06F 3/041

(52) U.S. Cl. CPC G06F 3/041
USPC 345/173

(57) ABSTRACT

An apparatus and a method for releasing a lock function set in advance by detecting a user's input in an electronic device increases the security level required to access the electronic device. A method for controlling the lock function in the electronic device includes determining pattern input information. After determining the pattern input information is valid by analysis with predetermined pattern information, the lock function is released. The pattern input information includes at least one of a pattern shape, a pattern input time, a pattern input position, and a pen pressure of a pattern. The apparatus includes a touchscreen configured for detecting gestures, use of a stylus within a pre-determined threshold, and touch. The device discerns whether input has been entered in a proper hidden region of the display, to reduce unauthorized access by someone observing the input pattern being entered.

### CLAIM OF PRIORITY

This application claims the benefit of priority under 35 U.S.C. §119(a) from a Korean patent application filed in the Korean Intellectual Property Office on Jul. 6, 2012 and assigned Serial No. 10-2012-0073912, the entire disclosure of which is hereby incorporated by reference in its entirety.

### BACKGROUND

1. Field of the Invention

The present disclosure relates to an apparatus and a method for a lock function in an electronic device. More particularly, the present disclosure is related to detecting a user's input to release a predetermined lock function in an electronic device such as on a touch screen to an input pattern.

2. Description of the Related Art

Electronic devices such as smartphones, tablets, phablets, etc., have become a necessity of modern people due to the ease of portability coupled with functions far beyond simple voice communication. Accordingly, such electronic devices have evolved over time into a multimedia devices providing various services such as a voice and video communication function, an information input/output function, and data storing. People access the Internet and use the electronic devices to pay bills, purchase consumer goods, entertainment, etc.

As described above, as an electronic device continues to increasingly provided multimedia services, and some electronic devices can output in high definition resolution, thus the an amount of information to be processed and an amount of information to be displayed continues to increase. Accordingly, an interest in an electronic device having a touchscreen that can increase a size of a display unit by improving space utilization increases.

The touchscreen is an input/display unit for performing command or data inputs and displaying information on a single screen. Accordingly, in devices that have a touchscreen, the electronic device may increase a display area by removing a separate input unit such as a keypad, and/or may be considerably thinner as well as having a larger display. For example, in a scenario where a full touch configuration is applied to an entire touchscreen, a front side of the electronic device is utilized as a screen, so that a screen size may be increased.

In addition, the electronic device to which the touchscreen is applied may permit writing text or drawing a line using an input tool such as a stylus pen and an electronic pen, in addition to typing.

Conventional devices often have a touch lock function in order to prevent a touch malfunction from unintentional content, and to increase the security of the electronic device. Generally, the electronic device releases a touch lock function by detecting a user's input pattern. In other words, the electronic device compares the user's touch input detected during a touch lock state with a movement pattern stored in advance to release touch lock state. For example, the electronic device detects the user's input moving on a path of a point output during the touch lock state, but the path of the point is easily exposed to other people, and can be memorized/copied to gain unauthorized access to the electronic device.

In other words, in the case where other people can easily observe and remember the user's input pattern, other people may release the lock function to access the electronic device without the user's permission.

More particularly, as a storage space of the electronic device increases recently and use of a services that access personal information such as a financial service are becoming more popular, the electronic devices can either store or retrieve personal information that should be protected is stored. However, in the case where security of the lock function is vulnerable to theft by observing a user pattern as described above, personal information can be comprised and cause significant harm to the person having such data or access to such data obtainable from the electronic device.

Accordingly, to resolve the above problem, there is a long-felt need in the art for an apparatus and a method for providing a lock function that improves security in an electronic device.

### SUMMARY

An aspect of the present invention is to address at least some of the above-mentioned problems and/or disadvantages and to provide at least the advantages described below. Accordingly, an exemplary aspect of the present invention is to provide an apparatus and a method for improving security of a lock function in an electronic device.

Another exemplary aspect of the present invention is to provide an apparatus and a method for analyzing a user's input pattern using a pattern input time, an input position, a pen pressure, etc. in an electronic device.

Still another exemplary aspect of the present invention is to provide an apparatus and a method for separating and coupling input patterns in an electronic device.

Yet another exemplary aspect of the present invention is to provide an apparatus and a method for setting a cooperative function for each pattern in an electronic device.

Still another exemplary aspect of the present invention is to provide an apparatus and a method for loading a different environment for every user when releasing a lock function by setting a user profile for each pattern in an electronic device.

In accordance with an exemplary aspect of the present invention, a method for controlling a lock function in an electronic device is provided. The method preferably includes determining by a controller/microprocessor pattern input information; and when the controller determines that the pattern input information is valid by comparison with the predetermined pattern information, controlling the lock function, wherein the pattern input information includes at least one of a pattern shape, a pattern input time, a pattern input position, and a pen pressure of a pattern.

In accordance with another exemplary aspect of the present invention, an apparatus for controlling a lock function in an electronic device is provided. The apparatus includes at least one processor or microprocessor, a non-transitory machine readable memory, and machine executable code stored in the memory and when loaded into the processor or microprocessor for execution by the at least one processor or microprocessor, wherein the machine readable code when executed by the processor or microprocessor causes the processor or microprocessor to determine pattern input information, and when the processor or microprocessor determines that the pattern input information is valid by a comparison with the predetermined pattern information, controlling the lock function to unlock the touchscreen or unlock operation of one or more functions that can be performed by the electronic device. The pattern input information includes at least one of a pattern shape, a pattern input time, a pattern input position, and a pen pressure of a pattern.

In accordance with still another exemplary aspect of the present invention, a method for controlling a lock function in an electronic device is provided. The method is performed via operation of the electronic device by executing machine readable code, storing machine readable instructions that are executed by a controller, processor or microprocessor for determining pattern input information, and when the controller, processor or microprocessor is determined that the pattern input information is valid by analyzing the predetermined pattern information, the controller, processor or microprocessor controlling the lock function to unlock one or more operations of the electronic device, wherein the pattern input information includes at least one of a pattern shape, a pattern input time, a pattern input position, and a pen pressure of a pattern.

Other exemplary aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other exemplary aspects, features and advantages of certain exemplary embodiments of the present invention will become more apparent from the following description taken in conjunction with the accompanying drawings in which:

FIG. 1 is a block diagram illustrating one example of a configuration of an electronic device for providing a lock function according to an exemplary embodiment of the present invention;

FIG. 2 is a flowchart illustrating exemplary operation of a process for releasing a lock function of an electronic device according to an exemplary embodiment of the present invention;

FIG. 3 is a flowchart illustrating exemplary operation of a process for detecting a user's pattern input in an electronic device according to an exemplary embodiment of the present invention;

FIG. 4 is a flowchart illustrating exemplary operation of a process for detecting a user's pattern input in an electronic device according to another exemplary embodiment of the present invention;

FIG. 5 is a flowchart illustrating exemplary operation of a user pattern registration process for releasing a lock function in an electronic device according to another exemplary embodiment of the present invention;

FIGS. 6A, 6B, 6C and 6D are views illustrating a process for determining validity of an input pattern in an electronic device according to another exemplary embodiment of the present invention;

FIGS. 7A, 7B, 7C and 7D are views illustrating a sequential process for detecting a user's pattern input in an electronic device according to another exemplary embodiment of the present invention;

FIGS. 8A, 8B, 8C, and 8D are views illustrating a sequential process for detecting a user's pattern input in an electronic device according to another exemplary embodiment of the present invention;

FIGS. 9A, 9B, 9C and 9D are views illustrating a sequential process for detecting a user's pattern input in an electronic device according to another exemplary embodiment of the present invention;

FIGS. 10A, 10B and 10C are views illustrating a process of screen releasing a lock function in an electronic device according to another exemplary embodiment of the present invention;

FIGS. 11A, 11B, and 11C are views illustrating a screen releasing a lock function in an electronic device according to another exemplary embodiment of the present invention; and

FIG. 12 is a flowchart illustrating exemplary operation of a process for releasing a lock function of an electronic device according to another exemplary embodiment of the present invention.

Throughout the drawings, like reference numerals will be understood to refer to like parts, components and structures.

### DETAILED DESCRIPTION

The following written description with reference to the accompanying drawings is provided to assist a person of ordinary skill in the art with a comprehensive understanding of exemplary embodiments of the for the method and apparatus for improving security of a lock function of an electronic device invention as defined by the claims and their equivalents. The written description includes various specific details to assist an artisan with that understanding but these various specific details are to be regarded as merely exemplary. Accordingly, a person of ordinary skill in the art will recognize that various changes and modifications of the examples described herein can be made without departing from the scope and spirit of the claimed invention. Also, descriptions of well-known functions and constructions may be omitted for clarity and conciseness when their inclusion could obscure appreciation of the invention by a person of ordinary skill in the art.

Exemplary embodiments of the present invention described herein provide an apparatus and a method for improving security of a lock function of an electronic device using, for example, a pattern input time, an input position, a pen pressure, etc. as elements for automatically analyzing a user's input pattern in an electronic device. In addition, the lock function of the present invention prevents an unnecessary touch input unintended by a user from occurring, and includes a touch lock mode.

In addition, the electronic device may comprise a portable electronic device that communicates wirelessly, and is applicable to devices such as a portable terminal, a mobile phone, a media player, a tablet computer, a phablet, a handheld computer, and a Personal Digital Assistant (PDA), just to name a few non-limiting possibilities to which the present invention can be applied. Also, the electronic device may be an arbitrary portable electronic device including a device coupling two or more functions among these devices.

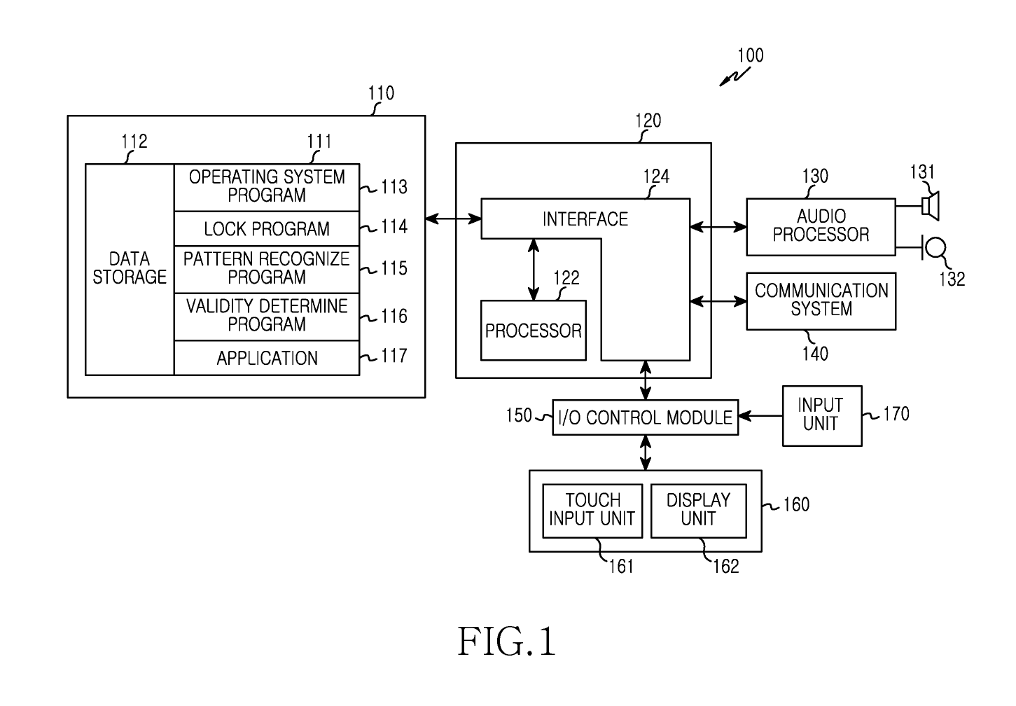

FIG. 1 is a block diagram illustrating an electronic device for providing a lock function according to an exemplary embodiment of the present invention.

As illustrated in FIG. 1, the electronic device 100 includes a memory 110, a processor unit 120, an audio processor 130, a communication system 140, an Input/Output (I/O) controller 150, a touchscreen 160, and an input unit 170. Here, a plurality of memories 110 and communication systems 140 may exist.

Each element is described below.

The memory 110 comprises a non-transitory machine readable medium includes a program storage 111 for storing a program that when loaded into hardware such as a controller, processor or microprocessor configures such hardware for controlling operation of the electronic device 100. The memory also provides a data storage 112 for storing data generated during execution of a program. For example, the data storage 112 stores various updatable data for storage such as a phone book, calling messages, received messages, a user's patterns for performing or releasing the lock function, and information regarding an input position of a pattern, an input time, a pen pressure, etc. In addition, the data storage 112 is designated by a user, and stores information regarding a hidden region, which is a region for detecting the user's input, a cooperative function for each user's pattern, information regarding a profile, etc. However, an artisan understand and appreciates that the non-transitory machine readable medium comprising the memory is shown in a logical apportionment that does not limit how the memory stores or apportions memory. For example, while not preferable, the memory could also scatter-load all the executable code and other data contained therein.

Also, the program storage 111 includes storage of an operating system program 113, a lock program 114, a pattern recognize program 115, a validity determine program 116, and at least one application 117. Here, a program included in the program storage 111 is a set of machine readable instructions and may be also expressed as an instruction set that are loaded into hardware such as a controller, processor or microprocessor for execution of the various operations of the electronic device. An artisan should understand and appreciate that under the broadest valid interpretation, the claimed invention constitutes statutory subject matter in view of 35 U.S.C. §101 and does not constitute software per se.

The operating system program 113 includes various software elements in the form of machine executable code for controlling a general system operation. This control of the general system operation denotes memory management and control, storage hardware (device) control and management, power control and management, etc., for example. This operating system program 113 also performs a function for smoothing communication between various hardware (devices) and program elements (modules).

The lock program 114 includes at least one software element comprised of machine executable code for controlling to process a lock function. In other words, when a user's input is not detected for a predetermined reference time or a user's input for performing the lock function is detected, the lock program 114 performs the lock function for preventing an unnecessary touch input unintended by the user from occurring, or to prevent unauthorized access in the event the user, for example, moved away from the device. In contrast, when the valid user's input (pattern input, number input, touch movement, etc.) for releasing the lock function is detected, the lock program 114 processes to release the lock function. Also, when determining that the user or possibly other people tries to perform a release the lock function, the lock program 114 can require receipt of authentication information from the user. For example, after one or more retries, the electronic device may request authentication information. Here, the situation where other people try to release the lock function may be a situation where an unauthorized user's input is detected as occurring for a predetermined number of times. At this point, the authorized user's input for releasing the lock function can be determined by the validity determination program 116.

Moreover, operation of the lock program 114 by a processor 122 may function to detect the user's input to release the lock function, and then process the input to perform a predetermined cooperative function. For example, after releasing the lock function, the processor 122 configured with the lock program 114 may output a background screen or execute an application designated by the user depending on information set in advance.

In addition, the processor 122 configured with the lock program 114 may detect a user's input to release the lock function, and then process to load an environment corresponding to the user's profile. For example, after releasing the lock program, the processor 122 configured with the lock program 114 may control a display screen of the display unit (or touchscreen unit) to output a screen in which a particular theme defined by the user has been applied.

The pattern recognize program 115 includes machine executable instructions that when loaded for execution by the processor functions to recognize the user's input in order to control the lock function.

More particularly, the processor 122 configured with the pattern recognize program 115 may detect the user's input to understand an input pattern, an input number, a touch movement, etc.

At this point, the processor 122 configured with the pattern recognize program 115 may separate or couple patterns input by the user to determine whether the user input merits unlocking the touchscreen. For example, the processor 122 configured with the pattern recognize program 115 may determine that a pattern input in only in a hidden region among patterns input by the user. In addition, the processor 122 configured with the pattern recognize program 115 may couple a plurality of patterns input discontinuously.

The validity determine program 116 comprises machine executable code that when loaded into a processor for execution determines whether a pattern input by a user constitutes a valid input for releasing the lock function using a pattern shape, a pattern input time, a pattern input position, a pen pressure, etc. In other words, the processor 122 configured with the validity determine program 116 analyzes the pattern shape, a time consumed from a point at which the pattern input has started to a point at which the pattern input has been completed, an input time of a specific section, an input maintain time of a specific point, a pen pressure that has input the pattern, etc., and then compares them with information set in advance to determine the validity.

The application 117 includes machine executable code that when loaded into a processor for execution provides operation of at least one application installed in the electronic device 100.

The processor unit 120, which comprises hardware and includes at least one processor 122 and an interface 124. Here, the processor 122 and the interface 124 may be integrated as at least one Integrated Circuit (IC) or realized as separate elements. An artisan can understand and appreciate that the processor unit constitutes statutory subject matter, and the use of the word “unit” does not under the broadest valid interpretation set forth by the inventors constitute pure software, software per se, or non-statutory subject matter in the appended claims The interface 124 serves as a memory interface for controlling communication access between the processor 122 and the memory 110.

In addition, the interface 124 serves as a peripheral interface for controlling connection between an I/O peripheral device and the processor 122 of the electronic device 100.

The processor 122 is configured to control operation of the electronic device 10 to provide the lock function using at least one of the groups of machine executable code shown in the examples of elements 113, 114, 115, 116 and 117, for example. At this point, the processor 122 executes at least one program stored in the memory 110 to control to provide the lock function corresponding to a relevant program. For example, the processor 122 have processing performed by other elements in communication therewith so as to distribute some of the functionality. For example, processor 122 can include a lock processor for performing the lock function, pattern recognition, validity test, etc. In other words, the lock function of the electronic device 100 may be performed using software such as a program stored in the memory 110 that is loaded into hardware for execution such as the lock processor.

The audio processor 130 provides an audio interface between the user and the electronic device 100 via a speaker 131 and a microphone 132. The audio processor includes hardware such as a codec, for example.

The communication system 140 is configured to perform wired or wireless communication. For example, a communication function of wireless communication is provided for voice communication and data communication of the electronic device 100. At this point, the communication system may be divided into a plurality of communication hardware submodules supporting different communication networks. For example, though not limited thereto, the communication network includes a Global System for Mobile Communication (GSM) network, an Enhanced Data GSM Environment (EDGE) network, a Code Division Multiple Access (CDMA) network, a W-CDMA network, a Long Term Evolution (LTE) network, an Orthogonal Frequency Division Multiple Access (OFDMA) network, a wireless LAN, a Bluetooth network, a Near Field Communication (NFC) network, etc, just to name some non-limiting possibilities.

The I/O controller 150 provides an interface between an I/O unit such as a touchscreen 160, an input unit 170, etc. and the interface 124.

The touchscreen 160 is an I/O unit for performing an output display of information and receives an input of other information, and preferably includes a touch input unit 161 and a display unit 162.

The touch input unit 161 provides touch information sensed via a touch panel to the processor unit 120 via the I/O controller 150. The I/O controller also comprises hardware configured to control the touch screen, an optional input unit 170 such as a keyboard, pointing device, etc. When sensing touch information, the touch input unit 161 changes touch information to an instruction structure such as touch_down, touch_move, and touch_up, and provides the same information to the processor unit 120.

The display unit 162 displays on a display screen a status information of the electronic device 100, a character input by a user, a moving picture, a still picture, etc. For example, the display unit 162 displays a region for receiving a user's pattern controlling the lock function, and displays a pattern recognizing process. The display screen of the display unit can comprise one of LCD, LED, OLED, or any other thin-film technology (TFT) just to name some non-limiting possibilities.

The input unit 170 provides input data generated by the user's selection to the processor unit 120 via the I/O controller 150. In one example, the input unit 170 may include only a control button for controlling the electronic device 100. For another example, the input unit 170 may include a keypad for receiving input data from the user.

Though not shown, the electronic device 100 may further include elements for additional functions such as a camera module for shooting an image or a moving picture, a broadcast receiving module for receiving broadcasting, a digital sound source reproducing module such as an MP3 module, a short distance wireless communication module for short distance wireless communication, and a proximity sensor module for proximity sensing, etc., and associated machine executable code for operation.

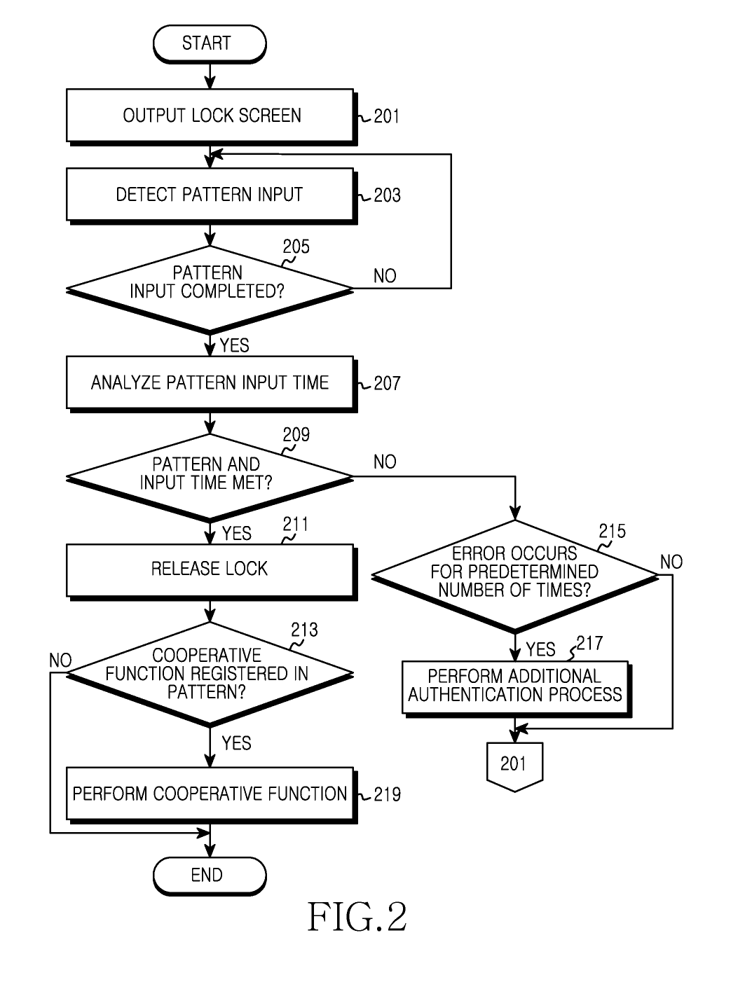

FIG. 2 is a flowchart illustrating exemplary operation of a process for releasing a lock function of an electronic device according to an exemplary embodiment of the present invention.

Referring now to FIG. 2, at step 201 the electronic device outputs a lock screen informing execution of the lock function.

At this point, the lock screen may include a state where an icon (for example, a slide bar) for releasing the lock function, and an icon (for example, a lock icon) for informing the lock function have been output, a state where a plurality of points for determining a touch input path have been output, etc.

At step 203, the electronic device detects a pattern input by a user. Here, the pattern input is the user's touch input for releasing the lock function, and denotes a touch input of the user moving with the touch input maintained. An example of the pattern input includes a touch movement, a character (signature) input, etc. The electronic device may output a region for receiving the user's pattern at a lock screen state.

In addition, when detecting that an electronic pen comes close (within a predetermined distance of the touchscreen that can be sensed by the electronic device) at the lock screen state, the electronic device may output a region for receiving the user's pattern, even though it is locked. Thus, the user is provided an opportunity to unlock the screen by entry of an input pattern that matches a predetermined value in storage.

At step 205, the electronic device determines whether or not the pattern input by the user is completed.

In determining at step 205 that the pattern input is not completed, the electronic device re-performs step 203 to detect the user's pattern input.

In contrast, at step 205 when it is determined that the pattern input is completed, the electronic device performs step 207 to analyze a pattern input time. At this point, the electronic device utilizes the user's pattern input time as criteria to determine whether or not the pattern input is a valid user's request for releasing the lock function.

At this point, the electronic device analyzes a time measured or deduced from a point at which the pattern input began to a point at which the pattern input has been completed, an input time of a specific section, an input maintain time of a specific point, etc. Here, the specific point may be an inflection point of the pattern input by the user, and the specific section may be at least one section formed by the inflection point.

The electronic device uses the pattern input time in determining whether or not the pattern input is a valid attempt by the user to unlock the screen in order to increase security of the lock function.

In other words, the pattern for releasing the lock function may be easily exposed and the lock function may be released by other people, but the present invention may increase security by using the pattern input time even when the pattern is exposed. This consideration of input time takes in to account a situation where other people may input the user's pattern similarly but at a time difference longer than a predetermined time that a valid pattern may occur during the similar input process. The predetermined time can be a threshold that is provided as default but could be set or changed by the user. Thus, more technically savvy reduce the pattern input time to a relatively very short time to reduce the possibility that somebody could try to successfully enter it and unlock the screen.

For example, the electronic device determines whether the pattern is a valid user's request for releasing the lock function using a movement direction and a movement velocity of an icon (for example, a slide bar) for releasing the lock function.

In addition, the electronic device determines whether the pattern is a valid user's request for releasing the lock function using an input shape and an input time of a character (signature) detected while an icon (for example, a lock icon) for informing the lock function is output.

In addition, the electronic device determines whether the pattern is a valid user's request for releasing the lock function using a touch movement and a movement velocity of the user going through a plurality of points.

At this point, the electronic device determines whether the pattern is a valid user's request for releasing the lock function using a movement velocity for a specific section, or an entire section, from among sections through which the user's input moves.

At step 209 the processor of the electronic device determines whether the input pattern and the pattern input time meet a predetermined reference.

In other words, at step 209 the electronic device determines whether a shape of the pattern input by the user and the input time are the same as information set by the user. In addition, in the case where the shape of the input pattern and the input time are not the same as the information set by the user, the processor of the electronic device may determine that the input pattern is a pattern input by other people to achieve unauthorized access. Accordingly, the electronic device prevents the lock function from being released.

At step 209, when the processor of the electronic device determines that the input pattern and the input time do not meet the predetermined reference the electronic device determines that an error has occurred in the input pattern. This error could be a misstep by the user, or may be a situation where the electronic device determines that the pattern has been input by other people.

At step 215, the electronic device determines whether a user error has occurred, or whether the pattern has been input by some attempting unauthorized access. This determination is made by the processor of the electronic device determining whether a pattern input error has occurred for a predetermined number of times. This predetermined count is to limit the number of attempts at access that can be made by an unauthorized user. When the electronic device determines that the pattern similar to the predetermined pattern for releasing the lock function has been input by other people has reached a predetermined plurality of a number of times (i.e. meets or exceeds a predetermined threshold), the electronic device can perform an additional authentication process for the user.

However, at step 215 when the pattern input error has occurred by less than the predetermined number of times, the electronic device performs step 201 to perform a process for detecting the user's pattern input.

In contrast, at step 215 in the case in which it is determined that the pattern input error has occurred by the predetermined number of times, the electronic device performs step 217 to provide the user with an additional authentication process. Here, step 217 is not a pattern authentication process for releasing the lock function but a process for authenticating a user, and may be a process for receiving an authentication number.

In addition, at step 209 in the case where the pattern and the input time are correct (meet the predetermined thresholds), the electronic device determines that an error has not occurred in the pattern input. Accordingly at step 211, the electronic device releases the lock function and then proceeds to perform step 213 to determine whether a cooperative function has been registered in the pattern that has released the lock function. Here, the cooperative function denotes a function set to be automatically executed after the lock function is released depending on a valid pattern input.

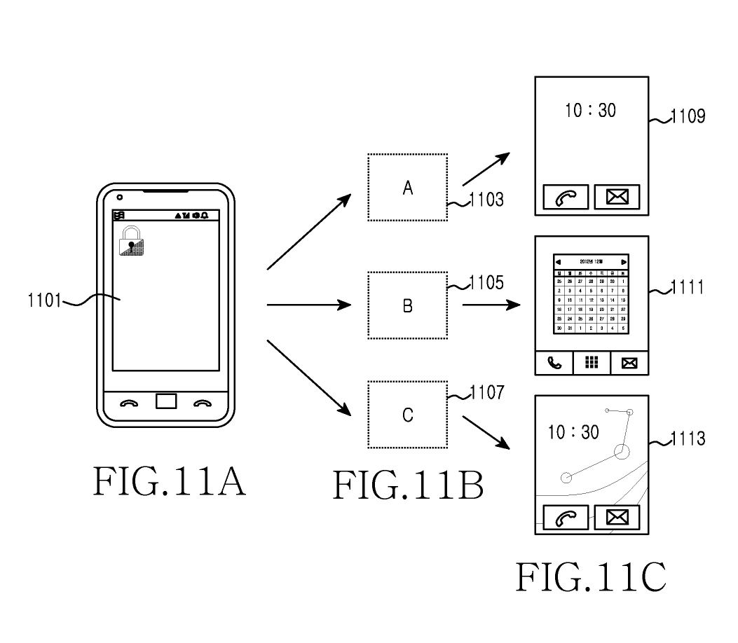

In addition, as illustrated in the series of screens shown in FIGS. 11A through 11C, when the lock function is released, the electronic device may output a screen configured using an application selected by the user or a screen to which theme set by the user has been applied.

At step 213, when the processor of the electronic device determines that the cooperative function has not been registered, the electronic device ends the present algorithm with the lock function released.

In contrast at step 213, when the processor of the electronic device determines that the cooperative function has been registered, the electronic device performs the cooperative function corresponding to the pattern that has released the lock function, and then ends the present algorithm.

Up to now, though FIG. 2 has described a method for determining a valid user's request for releasing the lock function using a shape of a pattern input by the user in conjunction with an input time. The electronic device according to the present invention can also detect a pen pressure (the user's pen pressure for a pattern) of the user who inputs the pattern, and a pattern input position to use them in determining whether the pattern is the valid user's request. The detected pen pressure can be an additional or substitute criteria for determining a valid user's request. An artisan should understand and appreciate that the claimed invention is not limited to pen pressure, and the pressure of a user's touch can also be determined.

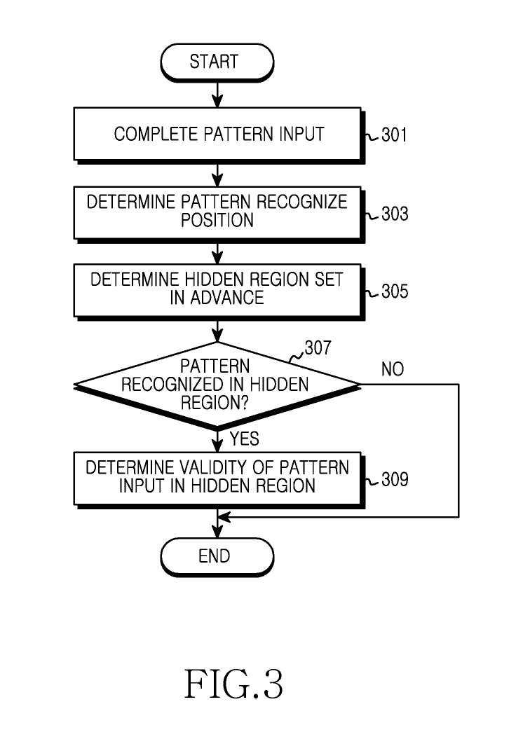

FIG. 3 is a flowchart illustrating exemplary operation of a process for detecting a user's pattern input in an electronic device according to an exemplary embodiment of the present invention.

Referring now to FIG. 3, the pattern input is a user's touch input for releasing the lock function, and denotes a touch input of the user moving with the touch input maintained. An example of the touch input includes a touch movement, a signature input, etc.

At this point, the processor of the electronic device sets a pattern input region designated by the user as a hidden region, and processes to use a pattern input in only the hidden region in releasing the lock function.

At step 301 electronic device detects a pattern input by the user and determines whether a pattern input is complete.

With regard to determining that the pattern input has been completed at step 301, the electronic device then performs step 303 to determine a position at which the pattern input by the user has been recognized.

Next at step 305, the electronic device determines the hidden region set in advance. Here, the hidden region denotes a region for receiving an actual pattern among regions for receiving the user's patterns at a lock screen state. In other words, the electronic device inputs a pattern in the hidden region which only the user knows in the display unit to process to release the lock function. Here, the hidden region is not displayed on the display unit but maintains a hidden state. Keeping the hidden state not visible allows the user of the electronic device to set the hidden region and the lock function not to be released by a pattern input outside the hidden region even when the pattern for releasing the lock function is exposed to other people.

At step 307, the electronic device determines whether the user pattern is recognized in the hidden region.

In the case at 307 where the user pattern is not recognized in the hidden region, the electronic device ends the present algorithm. In other words, when the user pattern is recognized in a region outside the hidden region, the electronic device determines same and does not perform the validity determine process itself for the input pattern.

In contrast at 307, in the case where the user pattern is recognized in the hidden region, the electronic device performs step 309 to determine validity of the pattern input in the hidden region. Here, the validity of the input pattern denotes a process for determining whether the shape of the pattern input by the user and the input time are the same as information set in advance.

The electronic device that has determined the validity releases the lock function or performs an authentication process for user authentication depending on the determination result, and then ends the present algorithm.

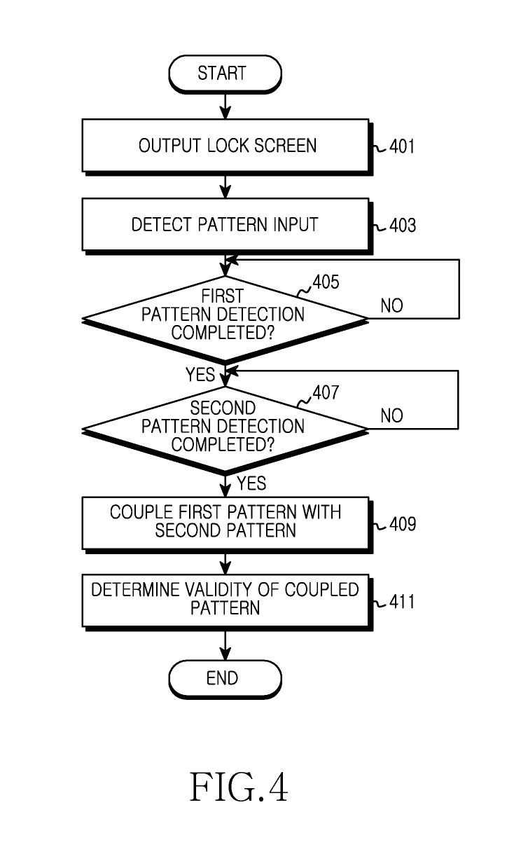

FIG. 4 is a flowchart illustrating a process for detecting a user's pattern input in an electronic device according to another exemplary embodiment of the present invention.

Referring now to FIG. 4, in an overview the processor electronic device couples patterns discontinuously input by the user to recognize a pattern and processes to release a lock function.

At step 401, the processor of the electronic device outputs a lock screen informing execution of the lock function.

At step 403, the processor of the electronic devices detects a pattern input by the user.

At step 405, the electronic device determines whether or not first pattern detection is completed. Here, the first pattern is a pattern input which the user has performed with one time of a touch input, and may be a portion of a pattern input for releasing the lock function.

At step 405, in the case where the first pattern detection is not completed, the electronic device repeatedly performs the process of step 405.

In contrast at step 405, when the electronic device determines that the first pattern detection is complete, the electronic device performs step 407 to determine whether a second pattern detection is completed.

Here, the second pattern comprises a pattern input performed as another touch input after the first pattern is input, and may be the rest of the pattern except the first pattern from among the pattern input for releasing the lock function.

At step 407, when the second pattern detection is not completed, the electronic device repeatedly performs the process of step 407.

In contrast, at step 407 when the second pattern detection is completed, the electronic device performs step 409 to couple the first pattern and the second pattern input by the user.

At step 411, the processor of the electronic device determines the validity of the coupled pattern. Here, the validity of the coupled pattern denotes a process for determining whether the shape of the coupled pattern and the input time are the same as information set in advance. The electronic device that has determined the validity releases the lock function, or performs an authentication process for user authentication depending on the determination result and then ends the present algorithm.

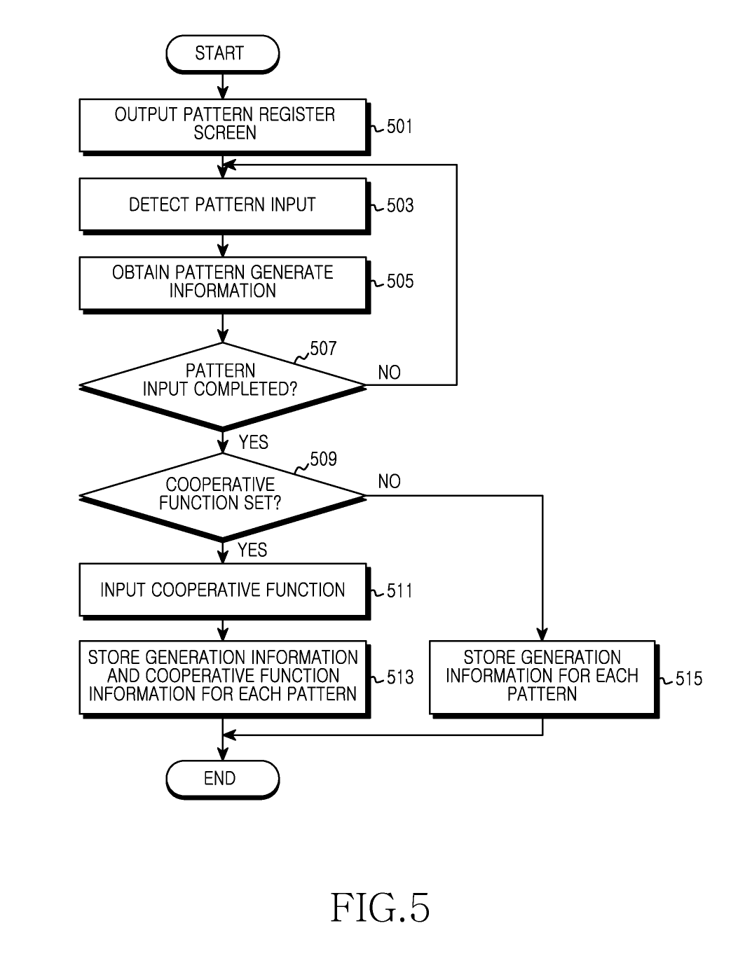

FIG. 5 is a flowchart illustrating exemplary operation of a user pattern registration process for releasing a lock function in an electronic device according to another exemplary embodiment of the present invention.

Referring now to FIG. 5, at step 501 the electronic device outputs a pattern registration screen for receiving a user's pattern.

Next at step 503 the processor of the electronic device detect the user's pattern input.

At 505, the electronic device obtains a pattern generation information while detecting the user's pattern input. Here, the pattern generation information may be one or more of a pattern input time, a pen pressure of a pattern input, a pattern input position, and a pattern shape. This pattern generation information may change depending on a pattern input position.

At step 507, the electronic device determines whether a pattern input by a user is completed.

In case at step 507 where the processor of the electronic device determines that the pattern input by the user is not complete, the electronic device re-performs step 503.

In contrast, at step 507 where the processor of the electronic device determines that the pattern input by the user is complete, the electronic device performs step 509 and determines whether to set a cooperative function. Here, the cooperative function denotes a function set to be automatically executed after the lock function is released depending on a valid pattern input. For example, the electronic device may execute an application using a cooperative function set in advance at a point at which the lock function is released by the pattern via cooperative function setting. In addition, the electronic device may load a different environment for each pattern when the lock function is released by setting a user profile for each pattern using a method like the cooperative function setting.

At step 509, when the processor of the electronic device determines whether the cooperative function or the user profile is not set to the pattern, and the electronic device performs step 515 to store generation information for each pattern.

Accordingly, in the case where a pattern input from the user meets pattern information, the electronic device processes to release the lock function.

In contrast at step 509, in case wherein the processor of the electronic device determines that the cooperative function or the user profile is set to the pattern, the electronic device performs step 513 to store the generation information for each pattern, and the cooperative function information or the user profile information. Accordingly, in the case where the pattern input from the user meets the pattern information, the electronic device may release the lock function and then execute the cooperative function.

At this point, the electronic device may perform a pattern input process for a predetermined number of times, and then average results of the pattern input process to obtain the generation of information for each pattern.

At step 513 the electronic device stores the pattern generation information and step 515 ends the present algorithm.

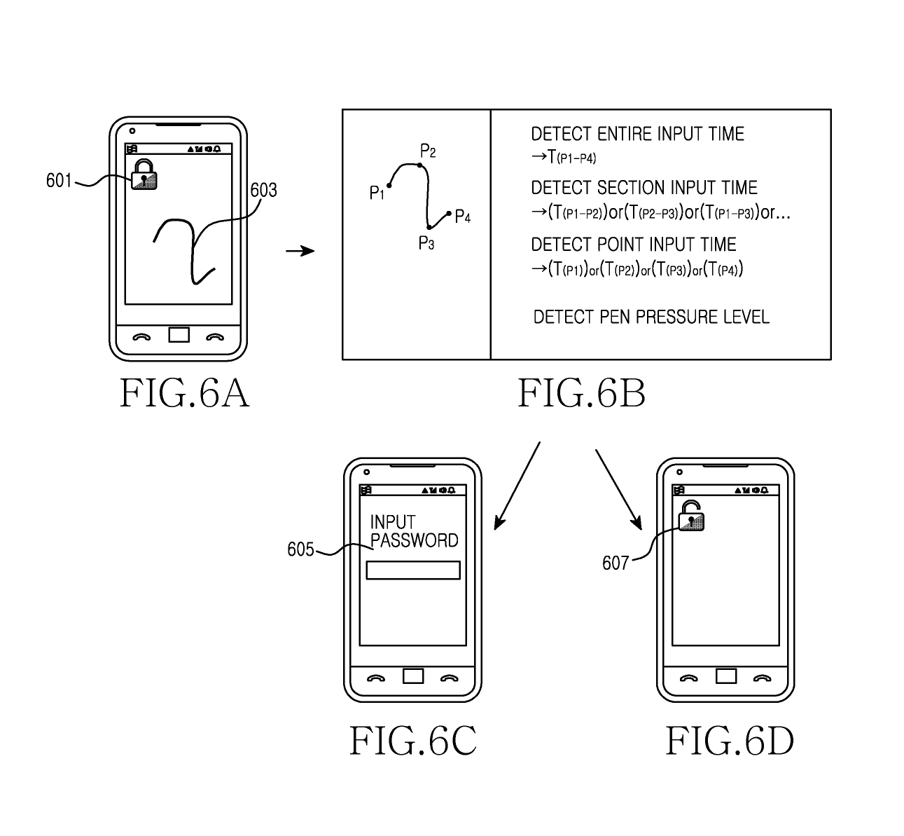

FIGS. 6A, 6B, 6C and 6D are views illustrating a process for determining validity of an input pattern in an electronic device according to another exemplary embodiment of the present invention.

Referring now to FIG. 6, the electronic device may determine validity by detecting a time consumed for inputting a pattern. The determination of validity can be performed for increasing security of the lock function using a fact that a time for which the user of the electronic device inputs the pattern and a pattern input time of other people are different from each other.

With regard to FIG. 6A, at 603, the electronic device receives a pattern at a state 601 where the lock function has been set as illustrated. Here, the pattern is the user's touch input for releasing the lock function, and is the user's touch input moving with the touch input maintained, and may be a touch movement, a signature, etc.

As shown in FIG. 6B, the processor of the electronic device determines whether a pattern input by the user is a pattern for releasing the lock function using a time consumed for inputting the pattern.

At this point, the electronic device analyzes a time from a point at which the pattern input has started to a point at which the pattern input has been completed, and/or an input time of a specific section, and/or an input maintain time of a specific point, etc., to use the same in determining the pattern. For example, when the pattern input by the user includes four inflection points, the electronic device measures a time for which an inflection point P1 to an inflection point P4 are input to use the same in determining the pattern.

In addition, the electronic device can also measure a time for which the inflection point P1 to an inflection point P2 or the inflection point P1 to an inflection point P3 are input to use the same in determining the pattern.

In addition, the electronic device measures an input time for which the electronic device stays to use the same in determining the pattern.

In addition, the electronic device can also be configured to detect a pressure (a user's pen pressure or touch for a pattern) of the user who inputs the pattern to use the same in determining the pattern. At this point, the electronic device may detect the pen pressure of an entire pattern input section or a portion of the pattern input section to use the same in determining the pattern.

The electronic device can utilize the shape of the pattern input by the user in determining the pattern basically.

The electronic device, having performed the analysis process for the pattern may optionally perform an additional authentication process (authentication process for the user) or release the lock function depending on the analysis result.

For example as shown in FIG. 6C, in case of where the electronic device determines that the pattern input by the user is not the pattern for releasing the lock function, the electronic device may perform an authentication process for authenticating a user.

At this point, in case of determining that an erroneous pattern is input by a predetermined number of times or more, the electronic device determines that a lock function release is tried by other people and performs the authentication process 605 for a user.

Referring to FIG. 6D, item 607 shows the lock has been released because the pattern input by the user is the pattern for releasing the lock function and/or the correct password entered.

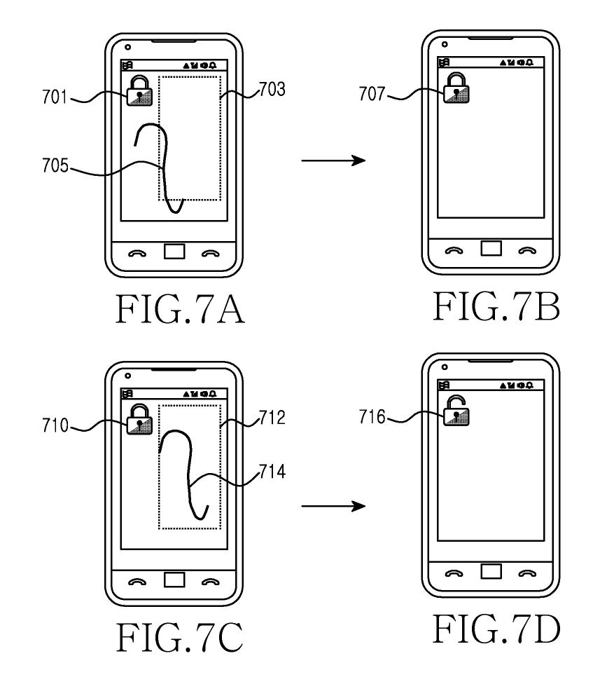

FIGS. 7A, 7B, 7C and 7D are a sequence of views illustrating a process for detecting a user's pattern input in an electronic device according to another exemplary embodiment of the present invention.

Referring now to FIGS. 7A, 7B, 7C and 7D, the electronic device provides a hidden region 703, which is a region actually in use, from among a region for receiving a pattern to determine whether to release the lock function using a pattern input in the hidden region.

Since the hidden region is not output on the display unit, only the user is allowed to know existence of the hidden region. Accordingly, even when the user's pattern is exposed to other people, the lock function cannot be released by the other people who do not know the precise existence of the hidden region.

In other words, in case of detecting the user's pattern input to a non-hidden region, the electronic device does not release the lock function as illustrated in FIGS. 7A and 7B. In this case, the electronic device does not perform a process for analyzing the shape of the pattern because the input pattern is partially outside region 703.

The electronic device illustrated in FIG. 7A outputs a screen for receiving the user's pattern at a state 701 where the lock function has been set. However, the electronic device designates (703) the hidden region where a pattern is actually received among the output screen to determine validity of the pattern only in the case where the pattern is input in the hidden region. Thus, only a partial input is received, and thus the electronic device will remain locked. Again, the dashed lines 703 are not visible to a user trying to enter the input pattern, so as to prevent others from being able to obtain unauthorized accessed.

In the case where a predetermined pattern (a valid pattern for releasing the lock function) is input (705) at a position outside the hidden region as illustrated in FIG. 7A, the electronic device maintains (707) the lock function as illustrated in FIG. 7B.

In contrast, in case of detecting the user's pattern input 714 being completely within the region designated as the hidden region 712, the electronic device determines validity of the detected pattern and processes to release the lock function as illustrated in FIGS. 7C and 7D.

The electronic device illustrated in FIG. 7C outputs the screen for receiving the user's pattern at a locked state 710 where the lock function has been set. However, the electronic device designates 712 as the hidden region where an actual pattern is input from among regions of the output screen and determines validity of the pattern only in the case where the pattern is input in the hidden region.

In other words, in the case where a predetermined pattern (a valid pattern for releasing the lock function) is input 714 inside the hidden region as illustrated in FIG. 7C, the electronic device determines validity of the input pattern and then releases 716 the lock function as illustrated in FIG. 7D. Again, the hidden region increases the level of security, as it is much harder for one observing the user from a short distance to actually determine where on the screen the pattern was input.

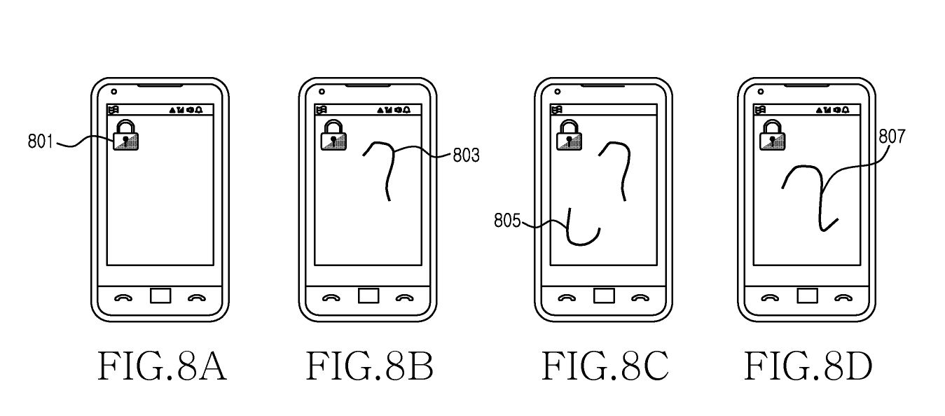

FIGS. 8A, 8B, 8C and 8D are view illustrating sequentially illustrating a process for detecting a user's pattern input in an electronic device according to another exemplary embodiment of the present invention.

Referring now to FIG. 8, the electronic device couples patterns input discontinuously and then recognizes the coupled pattern to process to release the lock function.

First, the electronic device outputs a screen for receiving a user's pattern at a locked state 801 where the lock function has been set. After that, the electronic device detects a pattern 803 input by the user as a first pattern as illustrated in FIG. 8B. At this point, the first pattern is a pattern input which the user has performed with one time of a touch input, and may be a portion of a pattern for releasing the lock function.

Next, the electronic device defines another pattern 805 input by the user after the first pattern is input as a second pattern as illustrated in FIG. 8C. Here, the second pattern is a pattern input which the user performs with another touch input after the user inputs the first pattern, and may be the rest of the pattern except for the first pattern from among the pattern input for releasing the lock function.

After that as shown in FIG. 8D, the electronic device couples the first pattern and the second pattern to generate one pattern 807. The electronic device then determines a validity of the coupled pattern to maintain or release the lock function.

An artisan understands and appreciates the claimed invention is not limited to two input pattern portions. It is also within the spirit and scope of the claimed invention that the input pattern portions have to be entered at previously designated regions of the display, or for example, they have to follow a clockwise, counterclockwise, or some other geometric pattern, such as a diagonal pattern, just to name a few non-limiting possibilities.

Here, though it is illustrated that the electronic device connects and couples the first pattern and the second pattern, the electronic device may determine validity of the pattern with the first pattern and the second pattern separated. In other words, the device does not have to display a connected first and second pattern. This means that not only a method connecting the first pattern with the second pattern but also a plurality of patterns may be used for the coupled pattern. An exemplary embodiment thereof is described below. In the case where the user stores a pattern using a signature, the user may release the lock function by inputting the signature as the first pattern and inputting a predetermined date as the second pattern.

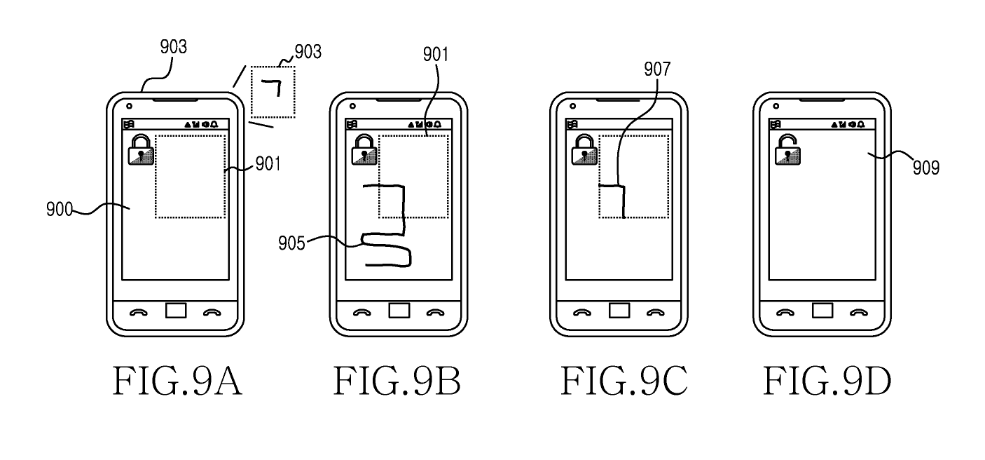

FIGS. 9A, 9B, 9C and 9D are views sequentially illustrating a process for detecting a user's pattern input in an electronic device according to another exemplary embodiment of the present invention.

Referring now to FIGS. 9A, 9B, 9C and 9D, the electronic device recognizes a portion of a user's pattern continuously input to process to release the lock function.

First, the electronic device outputs a screen 900 for receiving the user's pattern at a state where the lock function has been set as illustrated in FIG. 9A. At this point, the electronic device defines and stores in advance a pattern 903 for releasing the lock function, and designates a portion 901 of the output screen as a hidden region. This portion 9014 permits determining validity for only a pattern input in the hidden region from among all the patterns input by the user.

In other words, the electronic device detects a pattern 905 input by the user as illustrated in FIG. 9B. FIG. 9B illustrates that only a portion of the pattern input by the user of the electronic device belongs to the hidden region 901 and a portion of the pattern exists outside the hidden region.

After that, the electronic device ignores the user's pattern input outside the hidden region and obtains only a pattern 907 input inside the hidden region 901 as illustrated in FIG. 9C, and uses the obtained pattern as a pattern for releasing the lock function.

After that, the electronic device determines validity of the pattern recognized inside the hidden region, and when the obtained pattern coincides with the pattern for releasing the lock function, the electronic device releases the lock function state 909 as illustrated in FIG. 9D. An artisan understands and appreciates that other symbols, a word, or other indications can be used besides a padlock being shown to represent a locked or unlocked state. The device can also emit an indication, such as an audible beep or vibration, to indicate the device screen is unlocked.

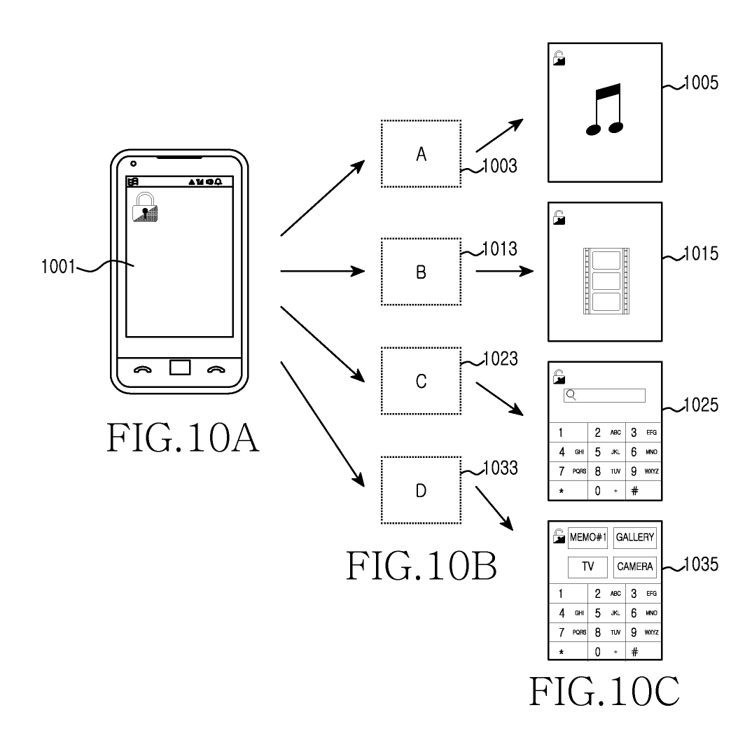

FIGS. 10A, 10B, and 10C are views illustrating a screen releasing a lock function in an electronic device according to another exemplary embodiment of the present invention.

Referring now to FIGS. 10A, 10B, and 10C, the electronic device releases the lock function according to a user's valid pattern input, and then processes to automatically execute a cooperative function defined for the pattern.

An operation of the electronic device performing the above operation is described below.

First, the electronic device 1001 to which the lock function has been set as illustrated in FIG. 10A detects a pattern input by the user to release or maintain the lock function.

At this point, the electronic device may set a cooperative function for each pattern for releasing the lock function and process to perform the cooperative function set in advance upon release of the lock function.

In other words, the electronic device sets a cooperative function illustrated in FIG. 10C to a pattern illustrated in the patterns of FIG. 10B.

For example, in the case where a cooperative function for reproducing music is set to a pattern A 1003, when determining that the pattern A is input, the electronic device releases the lock function and then executes the cooperative function to allow music to be reproduced 1005.

In contrast, in the case where a cooperative function for reproducing a movie is set to a pattern B 1013, when determining that the pattern B is input, the electronic device releases the lock function and then executes the cooperative function to allow a movie to be reproduced 1015.

In contrast, in the case where a cooperative function for retrieving contents is set to a pattern C 1023, when determining that the pattern C is input, the electronic device releases the lock function and then processes to enter 1025 a retrieve mode.

Moreover, when a pattern D 1033 is input, a multi-function mode 1035 is shown. FIGS. 11A, 11B, and 11C are views illustrating a screen releasing a lock function in an electronic device according to another exemplary embodiment of the present invention.

Referring now to FIG. 11, the electronic device releases the lock function according to a user's valid pattern input, and then processes to load an environment corresponding to the user's profile defined for the pattern.

An operation of the electronic device performing the above operation is described below.

First, the electronic device 1101 to which the lock function has been set as illustrated in FIG. 11A may determine a pattern input by the user to release or maintain the lock function.

At this point, the electronic device may set a profile for each pattern A, B, C for releasing the lock function and outputs a screen to which a profile corresponding to a pattern has been applied.

In other words, the electronic device may output a screen to which an environment illustrated in one of 1109, 1111 or 1113 shown in FIG. 11C corresponding to a pattern illustrated in FIG. 11B has been applied.

For example, the pattern A 1103 is a pattern set by a user 1 (father), in the case where a profile configured with only a time, a phone connect menu, and a message menu is applied to a main screen, when determining that the pattern A is input, the electronic device releases the lock function and then processes to output a screen 1109 configured with the time, the phone connect menu, and the message menu according to the profile.

In addition, a pattern B 1105 is a pattern set by a user 2 (mother), in the case where a profile configured with only a calendar, a phone connect menu, an Internet access menu, and a message menu is applied to a main screen, when determining that the pattern B is input, the electronic device releases the lock function and then processes to output a screen 1111 configured with the calendar, the phone connect menu, the Internet access menu, and the message menu according to the profile.

Moreover, a pattern C 1107 is a pattern set by a user 3 (brother), in the case where a profile configured with a time, a phone connect menu, an Internet access menu, and a message menu and having a background is applied to a main screen, when determining that the pattern C is input, the electronic device releases the lock function and then processes to output a screen 1113 configured with the time, the phone connect menu, the Internet access menu, and the message menu according to the profile. At this point, unlike the screen output by the pattern A, the output screen is a screen to which a background screen has been set.

An artisan understands and appreciates there can be more users or few users as shown.

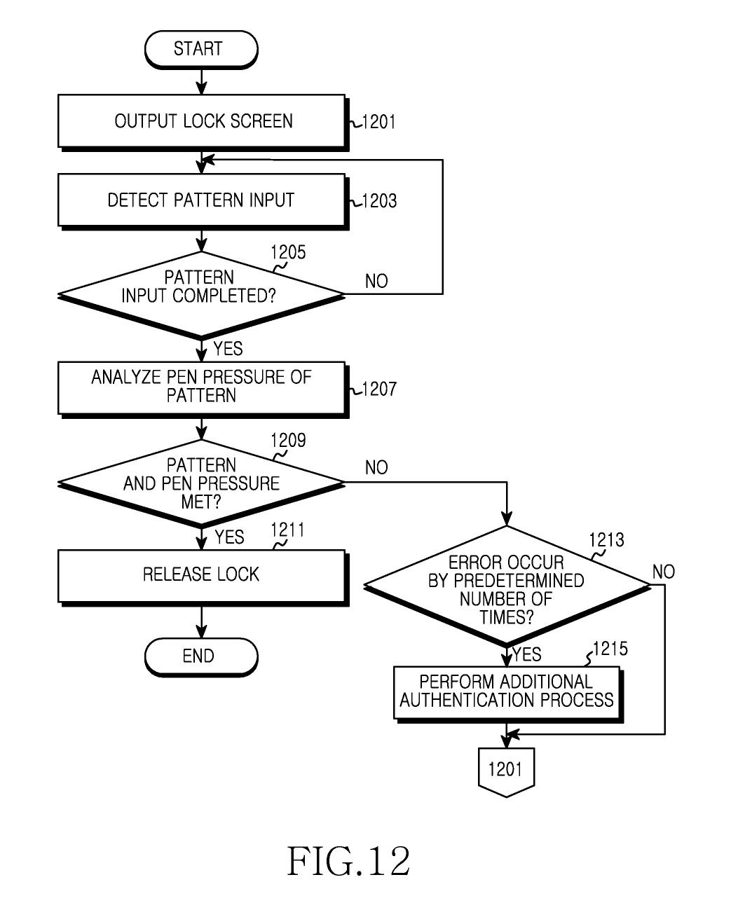

FIG. 12 is a flowchart illustrating exemplary operation of a process for releasing a lock function of an electronic device according to another exemplary embodiment of the present invention.

Referring now to FIG. 12, at step 1201 the electronic device outputs a lock screen informing execution of the lock function.

At this point, the lock screen may include a state where an icon (for example, a slide bar) for releasing the lock function has been output, a state where an icon (for example, a lock icon) informing the lock function has been output, and a state that has output a plurality of points via which a touch input path may be determined.

At step 1203, the electronic device o detects a user's pattern input. Here, the pattern input is the user's touch input for releasing the lock function, and denotes a touch input of the user who moves with the touch input maintained. An example of the pattern input may be a touch movement, a character (signature) input, etc.

At this point, the electronic device may output a region for receiving the user's pattern at a lock screen state.

In addition, when detecting that an electronic pen comes close at the lock screen state, the electronic device may output a region that can receive the user's pattern. No contact is required, for example, so long as the pen comes within a predetermined threshold distance to be detected by the electronic device.

After that, the electronic device preforms step 1205 to determine whether the user's pattern input is completed.

In case of determining that the pattern input is not completed in step 1205, the electronic device again performs step 1203 to detect the user's pattern input.

In contrast at step 1205, when the electronic device determines that the pattern input is completed, the electronic device performs step 1207 to analyze a pen pressure of the input pattern.

At step 1207, the electronic device defines the user's pen pressure as a plurality of levels to use the same in determining whether the input pattern is a valid user's request for releasing the lock function. The reason that pen pressure is a preferred way for user detection is because the user's pen pressure for inputting the pattern is not easily exposed to other people. Accordingly, by defining the user's pen pressure in detail, the electronic device increases security of the lock function. Then pen pressure could be determined by pressure sensors, or by the distance the screen is compressed, etc., (optically. for example).

At step 1209, the electronic device proceeds determines whether an input pattern and a pen pressure of the pattern meet a predetermined reference. In other words, at step 1209, the electronic device determines whether the shape of the pattern input by the user and the pen pressure level are the same as information set by the user.

If at step 1209 the input pattern and the pen pressure level do not meet the predetermined reference, the electronic device determines that an error has occurred in the pattern input. This error may be a situation where the electronic device determines that a pattern has been input by other people, or a user error.

At step 1213, the electronic device determines whether a pattern input error has occurred by a predetermined threshold number of times. This determination analyzes whether a pattern similar to a predetermined pattern for releasing the lock function has been input by other people by a plurality of number of times and performing an authentication process for a user.

At step 1213, in determining that a pattern input error has occurred by less than the predetermined threshold number of times, the electronic device again performs to step 1201 to perform a process for detecting the user's pattern input.

In contrast, at step 1213 in the case of determining that the pattern input error has occurred by the predetermined number of times or more, the electronic device performs step 1215 to perform an additional authentication process. Here, step 1215 is not a pattern authentication process for releasing the lock function but is a process for authenticating a user and may be a process for receiving an authentication number.

In addition, at step 1209 in the case where the input pattern and the pen pressure level meet the predetermined reference, the electronic device determines that an error has not occurred in the pattern input. Accordingly, the electronic device would perform step 1211 to release the lock function and ends the present algorithm.

Though a method for using the shape of a pattern input by a user and an input time in order to determine a valid user's request for releasing the lock function, a method for using the shape of the pattern input by the user and an input position, and a method for using the shape of the pattern input by the user and a pen pressure have been described separately in the above description, the electronic device according to the present invention may use the shape of the pattern input by the user, the input time, and the input position simultaneously to determine the valid user's request.

In addition, the electronic device according to the present invention performs a process for determining pattern input information including at least one of a pattern shape, a pattern input time, a pattern input position, and a pen pressure of a pattern in order to control the lock function, and a process for controlling the lock function when it is determined that the pattern input information is valid by pattern information set in advance.

After releasing the lock function, the electronic device performs a cooperative function corresponding to the pattern. When determining invalid pattern input information, the electronic device performs a process for authenticating a user.

In addition, the electronic device performs at least one of a process for coupling a plurality of patterns in one, a process for determining a pattern input in a predetermined region, and a process for separating a portion from an input pattern to determine pattern input information, and performs a process for setting a hidden region for receiving a user's pattern.

The electronic device may be executed by a program stored in the memory 110 of FIG. 1 and loaded into hardware such as a processor or microprocessor or controller, and determine pattern input information including at least one of a pattern shape, a pattern input time, a pattern input position, and a pen pressure of a pattern, and means for controlling the lock function when it is determined that the pattern input information is valid by pattern information set in advance.

The above-described methods according to the present invention can be implemented in hardware, firmware or as software or computer code that is stored in a recording medium such as a CD ROM, flash, EPROM, EEPROM, RAM, a floppy disk, thumbnail drive, a hard disk, or a magneto-optical disk, or computer code downloaded over a network originally stored on a remote recording medium and then stored on a non-transitory medium and loaded into hardware such as a processor, microprocessor, or controller. A sub-processor or additional processor may be configured to perform some of the functions disclosed herein as performing to the processor. The machine executable code stored on the non-transitory machine readable medium can be stored on a local recording medium, and is loaded into hardware such as a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor”, “microprocessor” or “unit” comprise hardware in the claimed invention. Finally, the claimed invention can include the use of a location information server comprising more than one server, such as a proxy server. Under the broadest valid interpretation, the claimed invention constitutes statutory subject matter in view of 35 U.S.C. §101 and does not constitute software per se.

As described above, the present invention is for improving security of the lock function in an electronic device and may improve security compared to the conventional lock function by using not only an input pattern but also a pattern input time, a position (input section), and a pen pressure element as a pattern determine element. In addition, the electronic device according to the present invention may improve security compared to the conventional lock function by allowing a user to set a desired pattern, and process to load a different environment for each pattern that releases the lock function by setting a cooperative function and a user profile every input pattern.

Although the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. A method for controlling a lock function in an electronic device, the method comprising:
detecting by a sensor that pattern information has been input on a touchscreen of the electronic device;
determining by a processor a validity of the pattern information input by a comparison with predetermined pattern information in storage that controls the lock function of the electronic device,
wherein the pattern information received by the touchscreen is compared by the processor with the predetermined pattern information in storage to determine the validity of the pattern information input comprises at least one of a pattern shape, a pattern input time, a pattern input position, and a pen pressure of a pattern when made on a touchscreen.

2. The method of claim 1, further comprising, after the processor releasing the lock function, performing a cooperative function corresponding to a pattern.

3. The method of claim 1, further comprising, when the processor determines that the pattern input information compared with the predetermined pattern information is not valid because the pattern input information does not match with the predetermined pattern information, the processor performing a process for authenticating a user.

4. The method of claim 1, wherein the determining of the pattern input information by the processor includes coupling at least one of a plurality of receive input patterns into a single pattern.

5. The method of claim 1, wherein determining the pattern input information includes determining whether a pattern has been input in a predetermined region of the touchscreen.

6. The method of claim 1, wherein determining the pattern input information includes separating a portion of an input pattern.

7. The method of claim 4, wherein the determining of the pattern input information comprises determining a hidden region for receiving a user's pattern,
wherein the hidden region is not output on a display unit.

8. The method of claim 1, wherein the predetermined pattern information comprises at least one of a shape of a pattern input, an input time of a pattern input, a pen pressure of a pattern input, and a hidden region for receiving a pattern.

9. The method of claim 1, wherein the pattern input time comprises an input time measured using an inflection point included in a pattern input,
wherein the pattern input time comprises at least one of a time consumed from a first point on the touchscreen at which the pattern input has started to an end point on the touchscreen at which the pattern input has been completed, an input maintain time of a specific inflection point, and an input time of a section formed by an inflection point and an inflection point.

10. The method of claim 1, further comprising, after releasing the lock function, the processor controls the touchscreen to output a screen to which a profile corresponding to a pattern has been applied.

11. An apparatus for controlling a lock function in an electronic device, the apparatus comprising:
a touchscreen;
at least one processor configured to detect input patterns received by the touchscreen and control a lock function;
a non-transitory memory including machine executable code that is loaded into the at least one processor for execution by the at least one processor,
wherein the at least one processor is configured for determining pattern input information received by the touchscreen, and for determining validity of the pattern input information by comparison with predetermined pattern information in storage for controlling the lock function to release the lock function when the pattern input information is determined to be valid, and
wherein the pattern input information detected by the touchscreen comprises one or more of a pattern shape, a pattern input time, a pattern input position, and a pen pressure of a pattern.

12. The apparatus of claim 11, wherein the processor is configured for, after releasing the lock function, performing a cooperative function corresponding to a pattern.

13. The apparatus of claim 11, wherein when the processor determines that the pattern input information is not valid, the processor performs a process for authenticating a user.

14. The apparatus of claim 11, wherein the processor is configured for determining a shape of an input pattern by performing coupling a plurality of received input patterns information into one received input.

15. The apparatus of claim 11, wherein the processor is configured for determining a pattern input in a predetermined region of the touchscreen, and for separating a portion of the input pattern.

16. The apparatus of claim 15, wherein the processor is configured for determining whether the pattern input information was input only within a hidden region of the touchscreen for receiving a user's pattern, and discarding any portion of the pattern information that is not detected within the hidden region, and
wherein the hidden region is not visible on a display unit.

17. The apparatus of claim 11, wherein the processor is configured for determining at least one of a shape of a pattern input, an input time of a pattern input, a pen pressure of a pattern input, and a hidden region of the touchscreen for receiving a pattern.

18. The apparatus of claim 11, wherein the processor is configured for measuring a pattern input time using an inflection point included in a pattern input,
wherein the pattern input time comprises at least one of a time consumed from a first point on the touchscreen at which the pattern input has started to a second point on the touchscreen at which the pattern input has been completed, an input maintain time of a specific inflection point, and an input time of a section formed by an inflection point and an inflection point.

19. The apparatus of claim 11, wherein the processor is configured for, after releasing the lock function, outputting a screen to which a profile corresponding to a pattern has been applied.

20. The apparatus according to claim 11, wherein the apparatus comprises a portable terminal further including:
an interface for providing communication between the processor and the memory, and
a wireless communication system under control of the processor comprising a transceiver.

21. The apparatus according to claim 11, wherein the apparatus further comprises an audio processor, and the transceiver of the wireless communication system transmits in short range communication and RF communication.
